(19) United States
(12) Patent Application Publication
(10) Pub. No.: US 2015/0130723 A1
(43) Pub. Date: May 14, 2015

(54) TWO STEP CONTENT SELECTION WITH TRAJECTORY COPY

(71) Applicant: Microsoft Corporation, Redmond, WA (US)

(72) Inventors: Jerry Huang, Beijing (CN); Zhen Liu, Tarrytown, NY (US); Chiu Chun Bobby Mak, Beijing (CN); Yang Gu, Beijing (CN); Ning Wang, Beijing (CN); Qing-Hu Li, Beijing (CN); Li Zhao, Beijing (CN)

(73) Assignee: Microsoft Corporation, Redmond, WA (US)

(21) Appl. No.: 14/074,774

(22) Filed: Nov. 8, 2013

(51) Int. Cl. G06F 3/041

(52) U.S. Cl. CPC G06F 3/041
USPC 345/173

(57) ABSTRACT

In a first step of a content selection operation, content can be selected by detecting a freeform trajectory of one or more content selection objects with respect to a computing device. The selection area can be calculated based on the maximum area covered by the trajectory of movement that is detected. The selection area can be limited to the area bounded by the start selection point and ending release point. The content within the selection area can be selected. The “roughly selected” content can be copied into a second display area. All or part of the roughly selected content can be enlarged, enabling precise selection of content in a second selection operation.

### CROSS-REFERENCE TO RELATED APPLICATIONS

The application is related in subject matter to co-pending U.S. patent application Ser. No. ______ (Docket No. 339706.01) entitled “TWO STEP CONTENT SELECTION”, filed on ______. The application is related in subject matter to co-pending U.S. patent application Ser. No. ______ (Docket No. 339716.01) entitled “TWO STEP CONTENT SELECTION WITH AUTO CONTENT CATEGORIZATION”, filed on ______.

### BACKGROUND

In many computer programs, selecting content involves the use of a selection object such as a mouse, touchpad, finger, stylus, etc. Selecting content is an example of a user operation that can be difficult under certain circumstances. For example, when the selection object (e.g., someone's finger) is larger than the selection zone, (e.g., an area on a touchscreen) it may become difficult to precisely select desired content. Similarly, environmental conditions (e.g., vibration or other movement) or motor impairment of the user can make precise selection of content difficult.

### SUMMARY

In a first step of a two step content selection operation, content can be selected by detecting movement of a content selection object with respect to a computing device. The selection area can be calculated based on the object movement that is detected. The selection area can be calculated by determining a rectangular area derived from coordinates of a start selection point and an ending release point of the content selection object. The selection area can be calculated by determining a rectangular area derived from coordinates of multiple start selection points and multiple ending release points of multiple content selection objects. The selection area can be calculated by determining a maximum rectangular area derived from overall movement of a selection object. If a partial paragraph is included in the selection object movement, the entire paragraph can be included in the selection area, even if the paragraph starts on a previous page or continues on a subsequent page. Alternatively, the selection area can be limited to coordinates of a start selection point and an ending release point of the content selection object. The content within the selection area can be selected. The content (i.e., initial content) selected in the first step of the content selection operation can be copied into a second display area. All or part of the initial content can be enlarged.

A second step of the content selection operation can be performed. The second step of the content can be used to precisely select content. The second step of the content selection operation can select a subset of the content selected in the first step of the content selection operation. Initiation of the second step of the selection operation can be detected by detecting movement of a content selection object with respect to the second display area. The second step of the selection operation can be detected by detecting a start selection indication and an end selection indication. The content (i.e., final content) selected by the second step of the content selection operation can be pasted into a specified destination (target). The content selected by the second step of the content selection operation can be edited before being pasted into the specified destination.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings:

FIG. 1a illustrates an example of a system 100 that enables two step content selection in accordance with aspects of the subject matter described herein;

FIG. 1b illustrates an example of source content displayed on a computing device in accordance with aspects of the subject matter described herein;

FIG. 1c1 illustrates the example of FIG. 1b in which a start selection point and an ending release point for the first step of the two step content selection have been detected in accordance with aspects of the subject matter described herein;

FIG. 1c2 illustrates another example of FIG. 1b in which a start selection point and an ending release point have been detected in accordance with aspects of the subject matter described herein;

FIG. 1c3 illustrates another example of FIG. 1b in which a start selection point and an ending release point have been detected in accordance with aspects of the subject matter described herein;

FIG. 1c4 illustrates another example of FIG. 1b in which a start selection point and an ending release point have been detected in accordance with aspects of the subject matter described herein;

FIG. 1c5 illustrates another example of FIG. 1b in which a start selection point and an ending release point have been detected in accordance with aspects of the subject matter described herein;

FIG. 1c6 illustrates another example of FIG. 1b in which multiple start selection points and multiple ending release points have been detected in accordance with aspects of the subject matter described herein;

FIG. 1d illustrates an example of the content of FIG. 1c1 in which a selection area is calculated in accordance with aspects of the subject matter described herein;

FIG. 1e1 illustrates another example of FIG. 1b in which a start selection point and an ending release point have been detected in accordance with aspects of the subject matter described herein;

FIG. 1e2 illustrates another example of the content of FIG. 1b in which a selection area is calculated in accordance with aspects of the subject matter described herein;

FIG. 1e3 illustrates another example of the content of FIG. 1b in which a selection area is calculated in accordance with aspects of the subject matter described herein;

FIG. 1e4 illustrates another example of the content of FIG. 1b in which a selection area is calculated in accordance with aspects of the subject matter described herein;

FIG. 1e5 illustrates another example of the content of FIG. 1b in which a selection area is calculated from the movement of multiple selection objects in accordance with aspects of the subject matter described herein;

FIG. 1f illustrates an example of a paste location in a target in accordance with aspects of the subject matter described herein;

FIG. 1g illustrates the example of FIG. 1f in which a second display area overlays the target display in accordance with aspects of the subject matter disclosed herein;

FIG. 1h illustrates the example of FIG. 1g in which a start selection point has been detected for the second step of the content selection operation in accordance with aspects of the subject matter disclosed herein;

FIG. 1i illustrates the example of FIG. 1h in which an end selection point has been detected for the second step of the content selection operation in accordance with aspects of the subject matter disclosed herein;

FIG. 1j illustrates the result of a paste operation in accordance with aspects of the subject matter disclosed herein;

FIG. 1k illustrates editing results of the second step of the content selection operation in accordance with aspects of the subject matter disclosed herein;

FIG. 1l illustrates the result of an edit and paste operation in accordance with aspects of the subject matter disclosed herein;

FIG. 2 illustrates an example of a method 200 that enables two step content selection in accordance with aspects of the subject matter disclosed herein; and

FIG. 3 is a block diagram of an example of a computing environment in accordance with aspects of the subject matter disclosed herein.

### DETAILED DESCRIPTION

### Overview

Currently, selection of content is typically based on precisely indicating the content to be selected by indicating a beginning and ending position in the content. For example, a user typically selects content by indicating a start position in the content and an end position in the content. The content that is selected is the content that includes the content at the indicated start position, the content at the indicated end position and the content that exists between the indicated start position and the indicated end position.

In accordance with aspects of the subject matter described herein, content from a source location can be selected by detecting movement of one or more selection objects across an area (e.g., a surface) of a computing device displaying the source content in a first display area. The movement of the selection object or selection objects can be used to calculate a selection area. The calculation can be based on the start selection point and an ending release point. The calculation can be based on multiple start selection points and multiple ending release points. The calculation can be based on a maximum area covered by the trajectory or path of the selection object, regardless of start selection point and ending release point. The calculation can be based on a maximum area covered by the trajectory or path of the selection object, bounded by the start selection point and ending release point.

The content within the calculated selection area can be selected. A target (e.g., file, spreadsheet, image, etc.) to which the copied content is to be pasted can be identified. A paste location at which content will be pasted within the target can be identified. The target can be displayed in a first target display area. The content within the calculated selection area can be copied into a second display area. The copied content can be enlarged and all or part of the enlarged content can be displayed in the second display area. A beginning location and an ending location within the second display area can be indicated to select a portion of the content selected in the first step of the content selection operation that is to be pasted into the target. The content selected in the second step of the content selection operation can be pasted into the target at the paste location. In accordance with aspects of the subject matter described herein, the content selected in the second step of the content selection operation can be edited before being pasted into the target.

Two Step Content Selection with Trajectory Copy

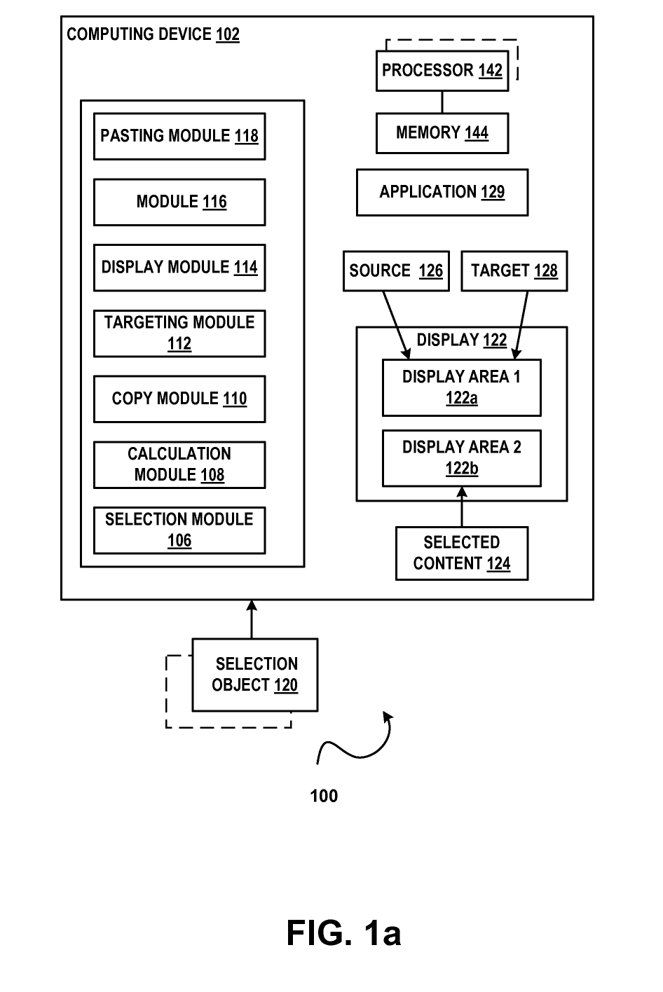

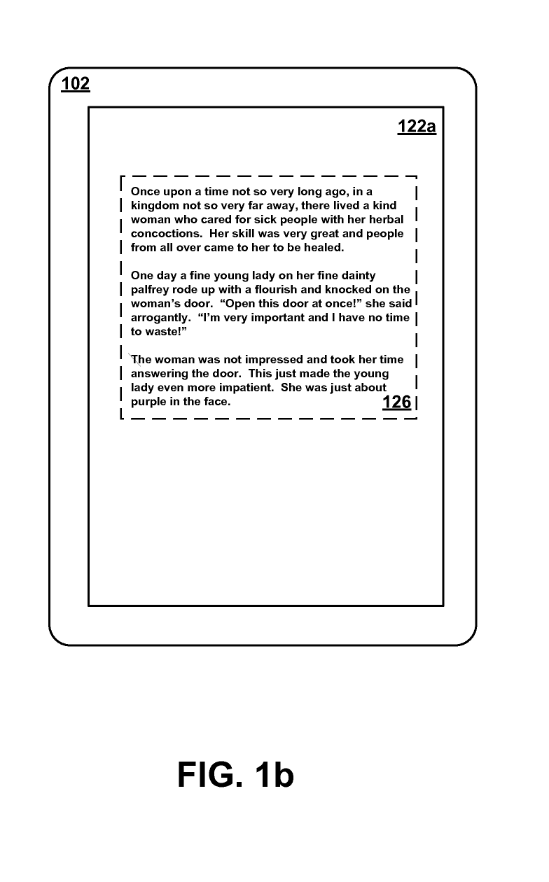

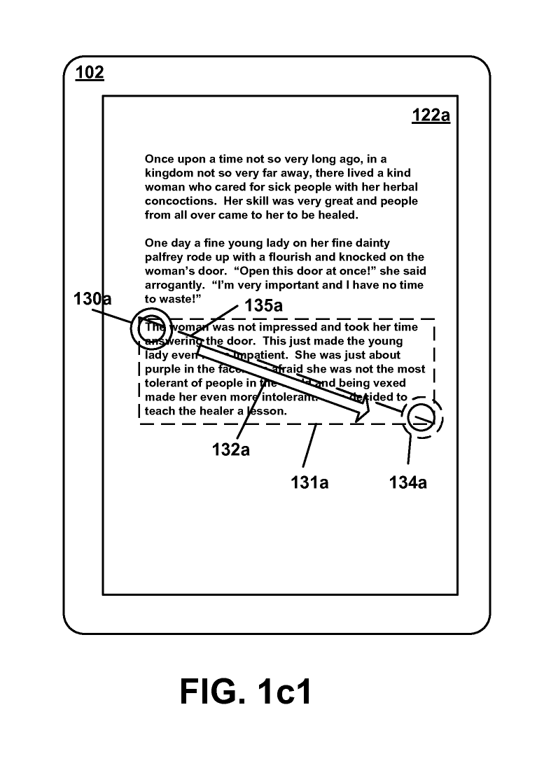

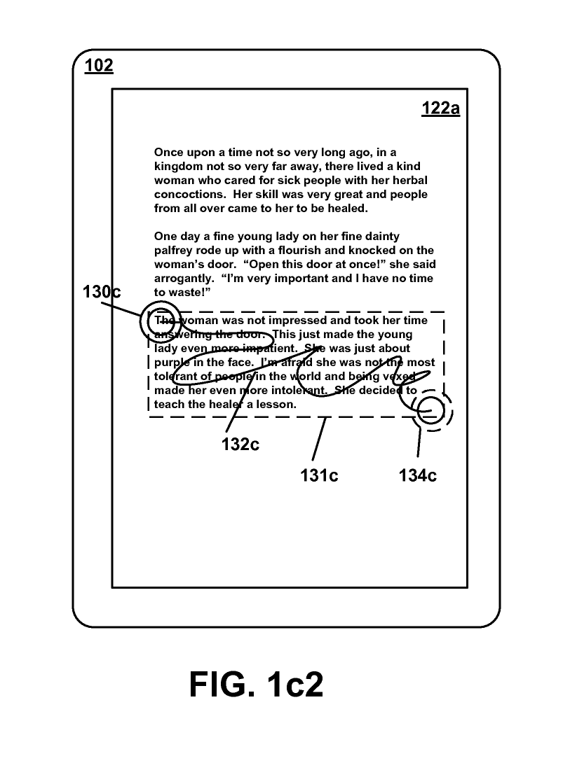

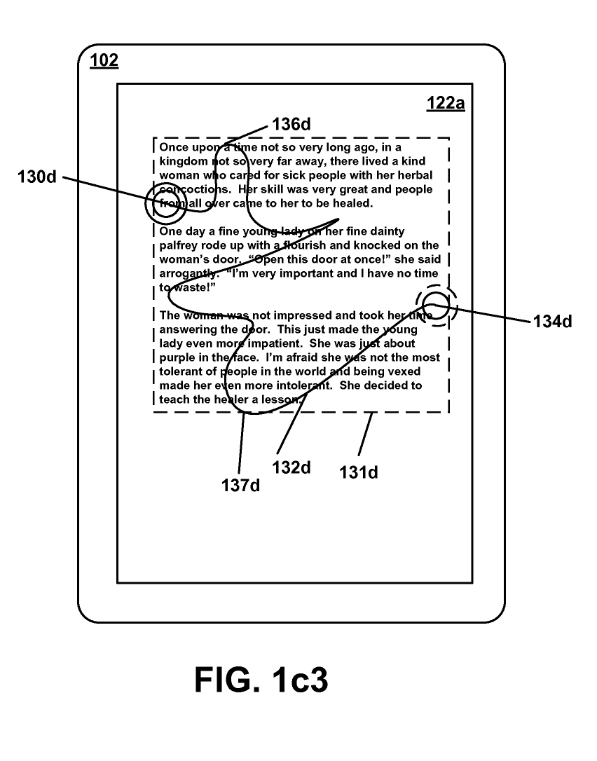

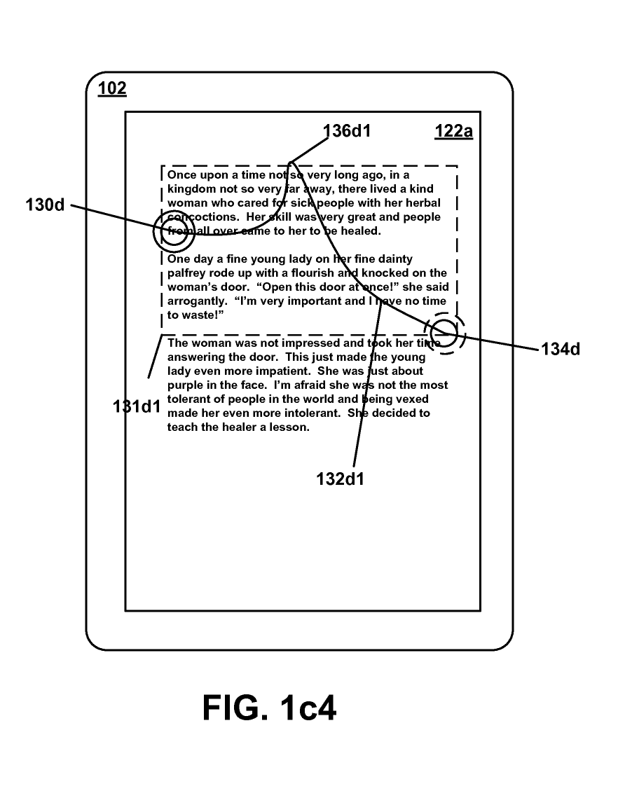

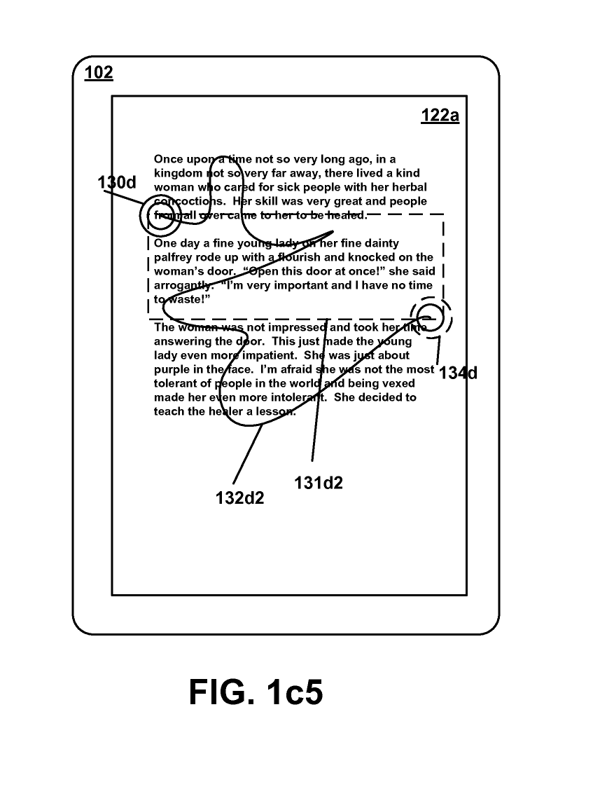

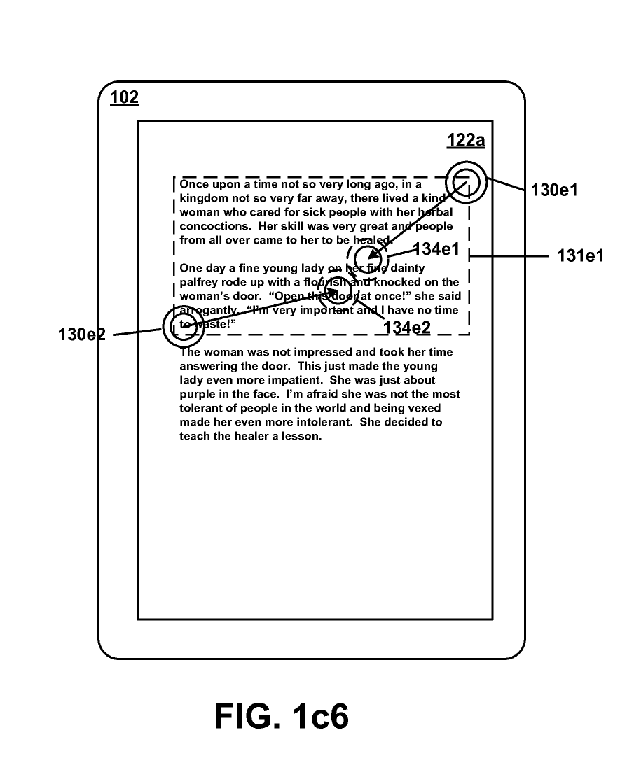

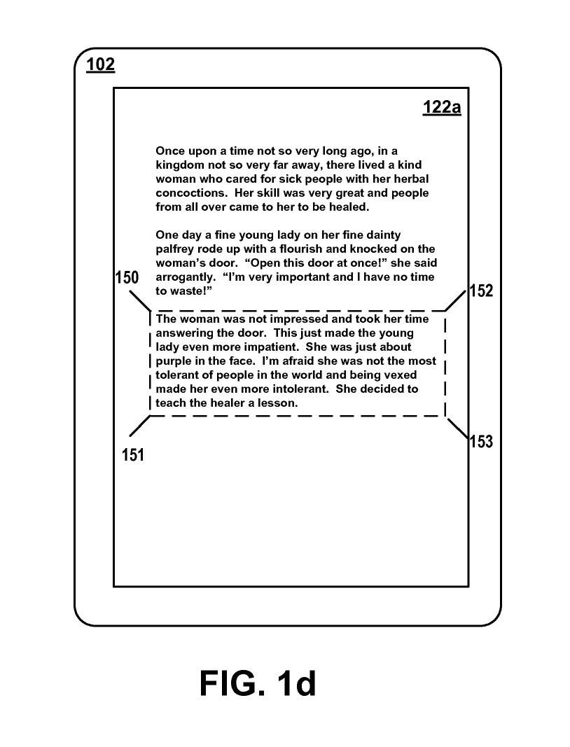

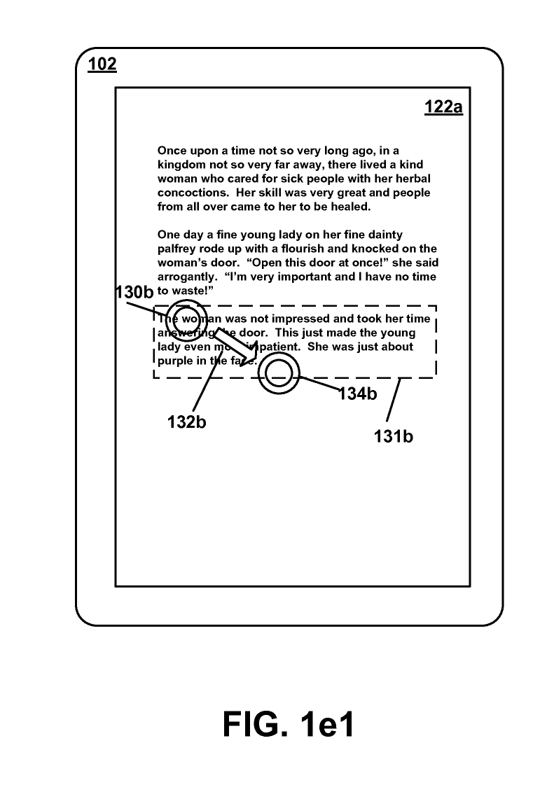

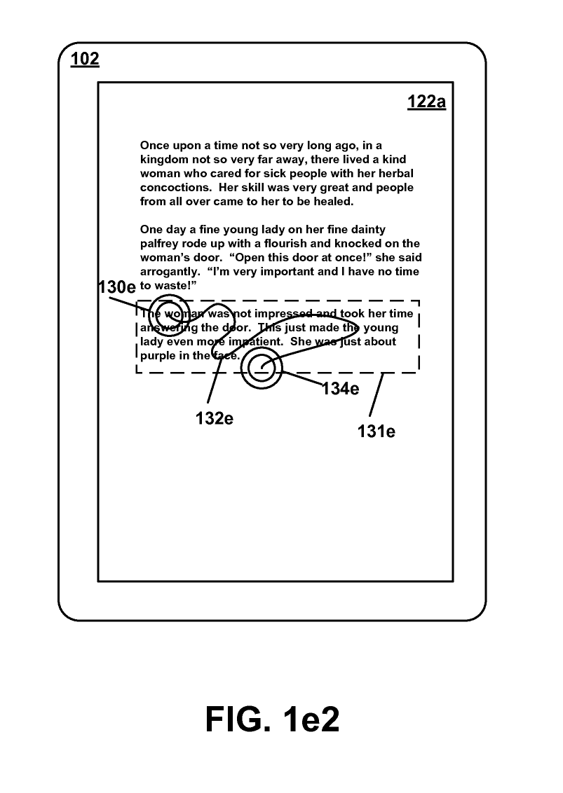

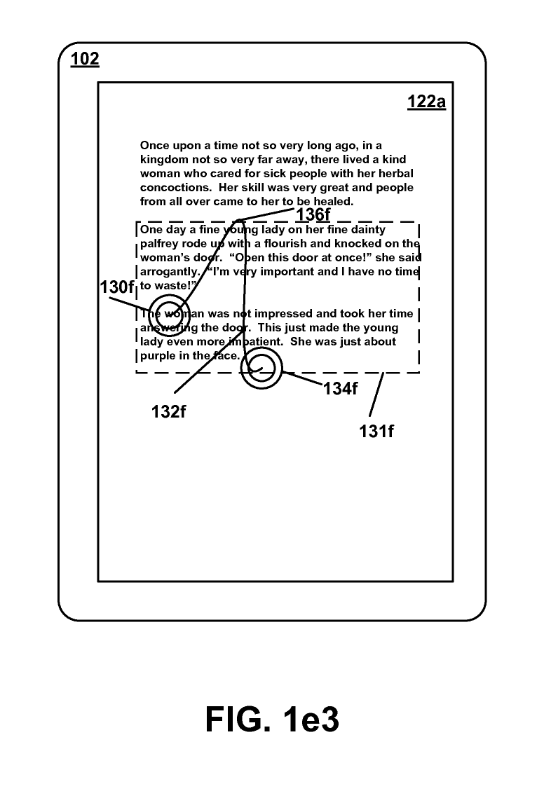

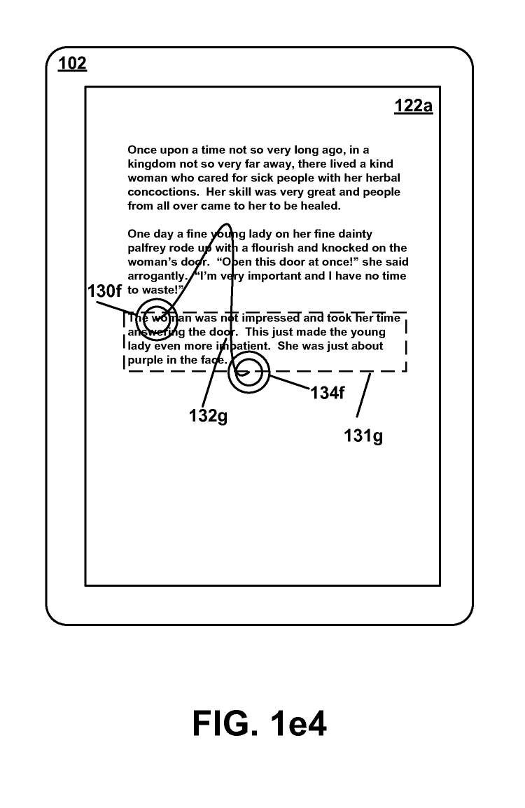

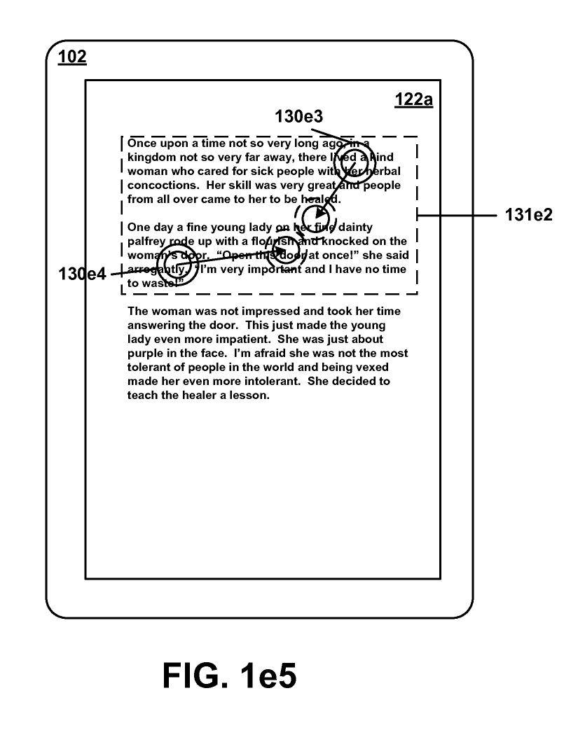

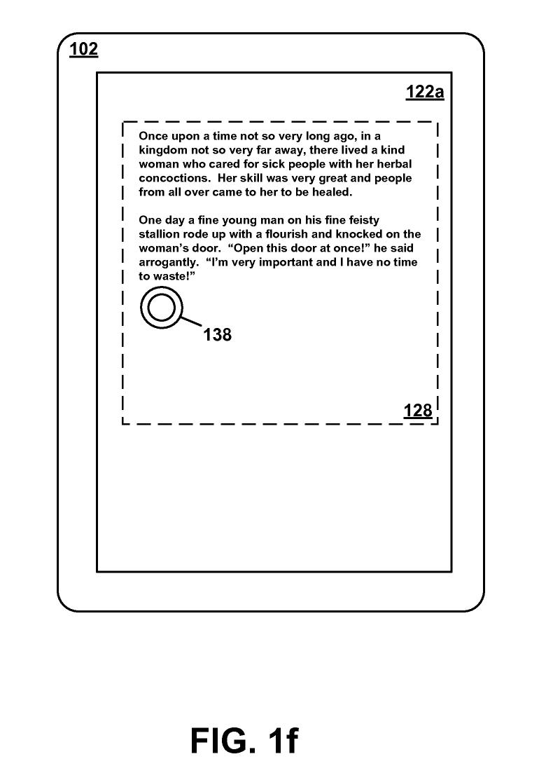

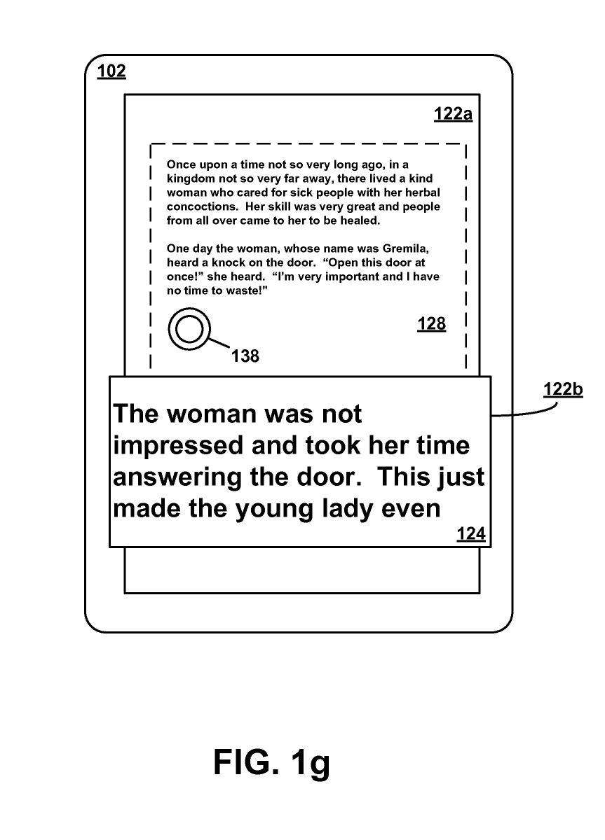

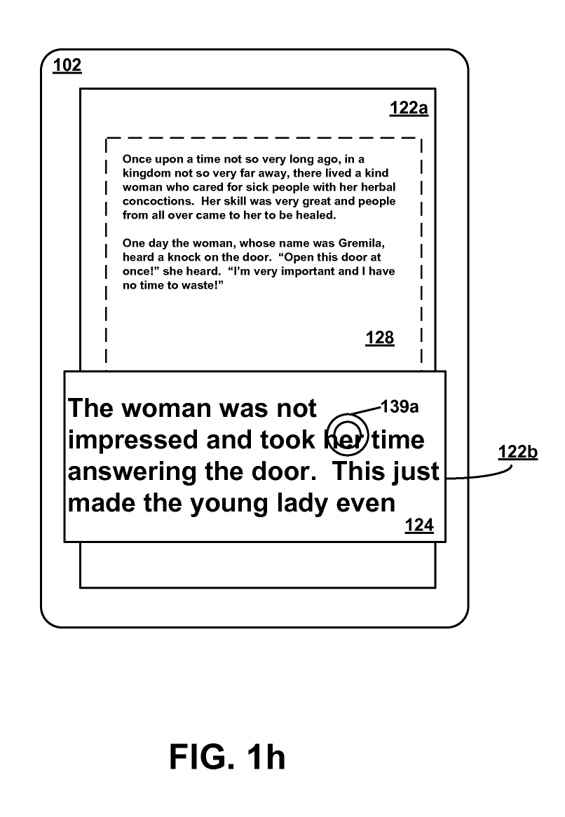

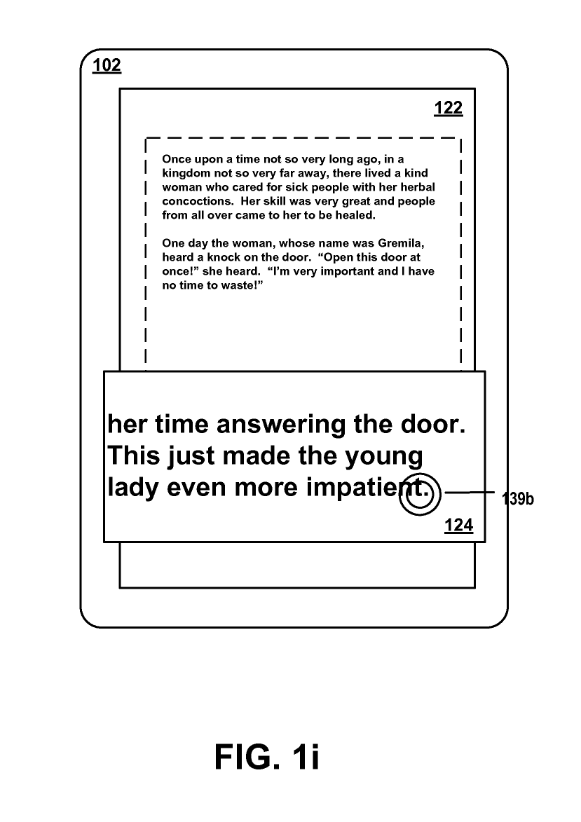

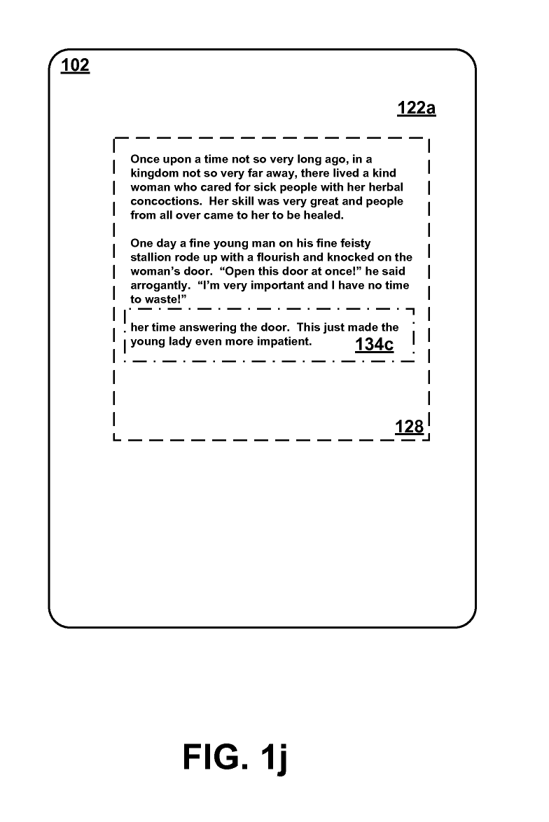

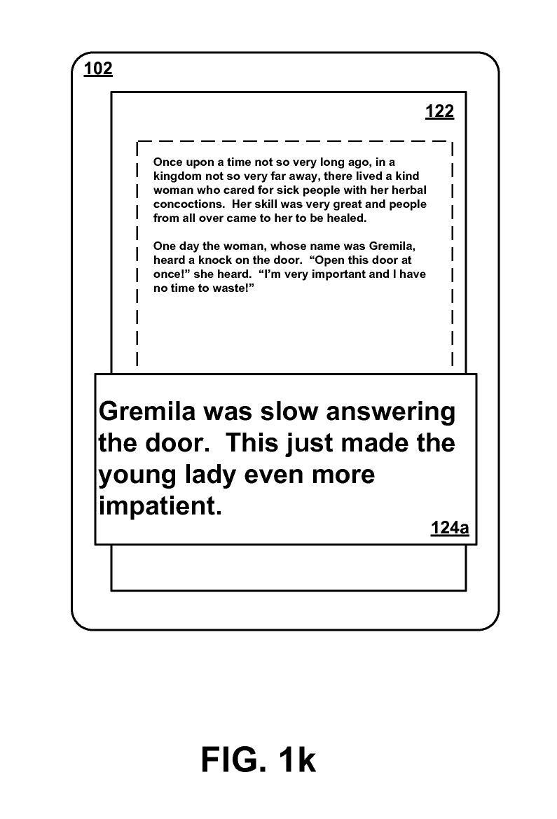

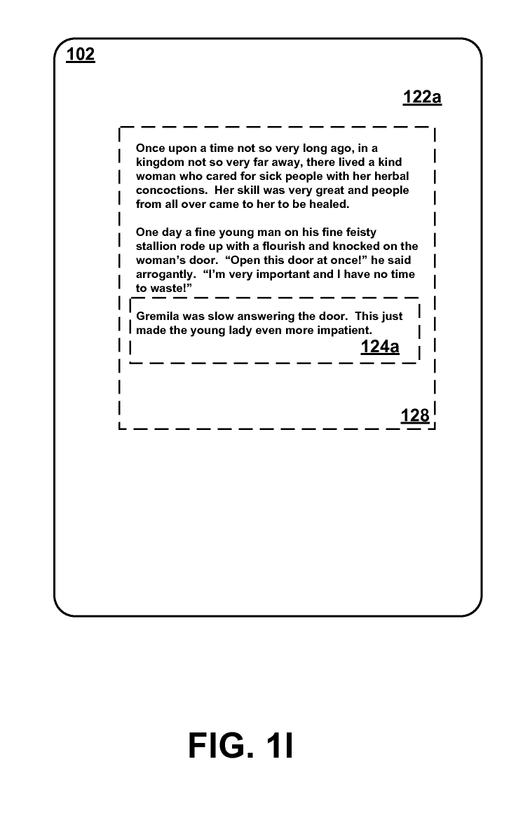

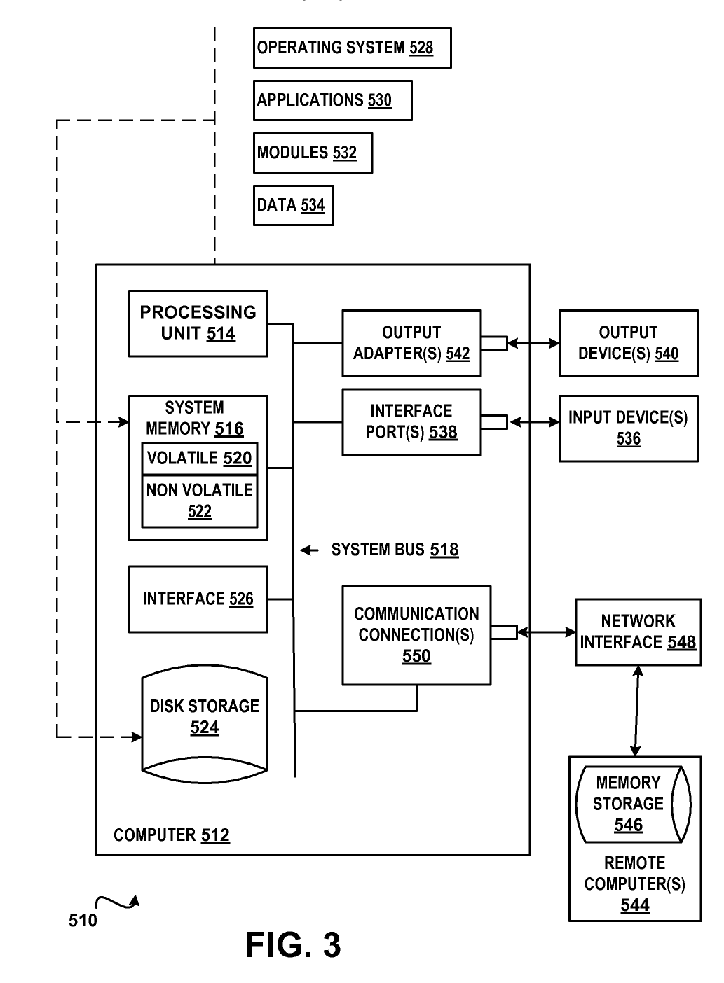

FIG. 1a illustrates a block diagram of an example of a system 100 that enables two step content selection. In the first step of the two steps, content from a source can be selected. In the second step of the two steps, all or some of the content selected in the first step can be selected. The content selected in the second step of the content selection operation can be pasted into a target in accordance with aspects of the subject matter described herein. All or portions of system 100 may reside on one or more computers or computing devices such as the computers described below with respect to FIG. 3. System 100 or portions thereof may be provided as a stand-alone system or as a plug-in or add-in.

System 100 or portions thereof may include information obtained from a service (e.g., in the cloud) or may operate in a cloud computing environment. A cloud computing environment can be an environment in which computing services are not owned but are provided on demand. For example, information may reside on multiple devices in a networked cloud and/or data can be stored on multiple devices within the cloud.

System 100 can include one or more computing devices such as, for example, computing device 102. Contemplated computing devices include but are not limited to desktop computers, tablet computers, laptop computers, notebook computers, personal digital assistants, smart phones, cellular telephones, mobile telephones, and so on. A computing device such as computing device 102 can include one or more processors such as processor 142, etc., and a memory such as memory 144 that communicates with the one or more processors.

System 100 can include one or more program modules represented in FIG. 1a by one or more of the following: one or more first selection modules represented in FIG. 1a by selection module 1 106 that selects content in a first step of a two step content selection operation, one or more calculation modules represented in FIG. 1a by calculation module 108, one or more copying modules represented in FIG. 1a by copy module 110, one or more targeting modules represented in FIG. 1a by targeting module 112, one or more display modules represented in FIG. 1a by display module 114, one or more second selection modules represented in FIG. 1a by selection module 2 116 that selects content in the second step of the two step content selection operation, and/or one or more pasting modules represented in FIG. 1a by pasting module 118. Module functions can be combined. For example, it is possible for one module to be able to perform both steps of the two step content selection operation and so on.

It will be appreciated that one or more program modules (e.g., selection module 1 106, calculating module 108, etc.) can be loaded into memory 144 to cause one or more processors such as processor 142, etc. to perform the actions attributed to the respective program module(s). It will be appreciated that computing device 102 may include other program modules known in the arts but not here shown.

System 100 can include one or more displays represented in FIG. 1a by display 122. Display 122 can be a touch screen. Display 122 can be a traditional display screen. Display 122 can be a high-resolution display. Display 122 may display content. “Content” as used herein can include but is not limited to: text data, image data, spreadsheet data (e.g., such as but not limited to a MICROSOFT's EXCEL® spreadsheet), calendar data (e.g., such as but not limited to a MICROSOFT's OUTLOOK® calendar) or any other content. Display 122 can include one or more display areas, represented in FIG. 1a by display area 1 122a and display area 2 122b. It will be appreciated that although two display areas are illustrated, the concept described is not so limited. Any number of display areas are contemplated.

A first display area such as, for example, display area 1 122a of FIG. 1a can display all or a portion of content from a content source, such as source 126. Display area 1 122a can display all or a portion of content from a content target, such as target 128. A second display area such as display area 2 122b can display selected content, illustrated in FIG. 1a as selected content 124. The content displayed in display area 2 122b can be enlarged or magnified. Selected content 124 can be content selected by a first step of a content selection operation. Selected content 124 can be content selected by a second step of a content selection operation. Selected content 124 can be selected content that has been edited.

In accordance with some aspects of the subject matter described herein, application 129 can be a word processing application (e.g., including but not limited to MICROSOFT's WORD®), a calendar application (e.g., including but not limited to MICROSOFT's OUTLOOK®), a spreadsheet application (e.g., including but not limited to MICROSOFT's EXCEL®), an image processing application or any application that manipulates content. Application 129 may be capable of editing content such as but not limited to selected content 124.

In accordance with some aspects of the subject matter described herein, a first display area such as display area 1 122a can display all or part of content from which a first selection is made, (e.g., a source from which content is selected) in the first step of a two step content selection operation. Display area 1 122a can display all or part of content into which content selected by the two step content selection operation is pasted. The content into which the content selected by the two step content selection operation is pasted can be a target such as target 128 for the pasting operation in which content selected in the second step of the two step content selection operation is pasted into the target. FIG. 1b illustrates an example of source content (e.g., source 126) displayed in display area 1 122a on a computing device 102. A second display area such as display area 2 122b can display the content selected by the first step of the two step content selection operation.

The second display area, display area 2 122b can display the content selected by the first step of the two step content selection operation to facilitate selection of content in the second step of the content selection operation. The second step of the content selection operation can facilitate selection of a subset of the content selected by the first step of the content selection operation. In the second display area all or part of the content (i.e., initial content) selected in the first step of the content selection operation, content (i.e., final content) selected in the second step of the content selection operation, or edited content can be displayed. The second display area can be a display for a content editor that enables editing of the content selected in the second step of the content selection operation. The second display area can be a display for pasting content selected in the second step of the content selection operation into a target.

Selection module 1 106 can receive input that indicates content to be selected. Selection module 1 106 can select the indicated content in a first step of a two step content selection. Execution of selection module 1 106 can be triggered by receiving a menu option selection, by receiving a voice command, by detecting a user gesture or in any way as is known in the art now or as is subsequently conceived.

Content to be selected by selection module 1 106 can be indicated by using one or more selection objects such as the selection objects represented in FIG. 1a by selection object 120, etc. A selection object can be any input device including but not limited to a mouse, trackball, stylus, or other suitable object. A selection object can be a body part such as a finger or other body part. Content to be selected can be indicated by, for example, using a finger on a touch screen. Selection module 1 106 may detect a selection operation by detecting movement of a selection object in contact with a touch-perceiving surface of the computing device. Selection module 1 106 may detect a selection operation by detecting proximity of a selection object to a surface of the computing device. Selection module 1 106 may detect a selection operation by detecting a beam of light such as a laser. Selection module 1 106 can determine coordinates of a start selection point and an ending release point as illustrated in FIG. 1c1 in which a start selection point 130a and an ending release point 134a have been detected. The content selected by selection module 1 106 in response to selection information can be determined by calculation module 108.

Calculation module 108 may receive selection information (i.e., first selection information) from selection module 1 106. The selection information received from selection module 1 106 can be used to calculate a content selection area that is based on the movement of the selection device on or in proximity to a surface of a computing device (e.g., movement of a finger on a touch screen). The content selection area can be calculated using the four vertices of a rectangle derived from the coordinates of a start selection point (e.g., start selection point 130a) and an ending release point (e.g., ending release point 134a). The start selection point can refer to the location on a display area 1 122a at which contact with a selection object is first detected. The start selection point can refer to the location in a file displayed on a display area 1 122a to which a selection object points.

Suppose for example, that display area 1 122a displays content from source 126. Content from source 126 or a portion or subset of content from source 126 can be selected by placing a selection object (e.g., a finger) on the display (e.g., a touch screen) at coordinates (x₁, y₁) (e.g., 130a) at which the desired content is displayed. Without breaking contact between the selection object and the display surface, the selection object can be moved across the surface of the display to a second point at coordinates (x₂, y₂). “Without breaking contact” means that contact between the selection object and the computing device is maintained in an uninterrupted fashion. In FIG. 1c1, the movement of the selection object across the display surface is roughly linear as illustrated by arrow 132a. In FIGS. 1c2-1c5, the movement of the selection object across the display surface is freeform as illustrated, for example, in FIG. 1c2 by freeform trajectory 132c. At the second point, (x₂, y₂), contact between the selection object and the surface of the display can be broken. The point at which the selection object is no longer detected by the selection module is referred to as the ending release point illustrated in FIG. 1c1 by ending release point 134a.

A diagonal line from the start selection point to the ending release point (e.g., diagonal line 135a in FIG. 1c1) can be used to create a rectangle (e.g., rectangle 131a in FIG. 1c1), the rectangle having four vertices calculated from the coordinates of the start selection point and the ending release point. That is, a rectangle can be formed, for example, using the coordinates (minimum x, maximum y) 150, (minimum x, minimum y) 151, (maximum x, maximum y) 152 and (maximum x, minimum y), 153 as illustrated in FIG. 1d where (minimum x, maximum y) is derived from the start selection point and (maximum x, minimum y) is derived from the ending release point. Similar logic can be applied when a freeform trajectory is detected, as illustrated in FIGS. 1c2, trajectory 132c.

The computation can determine two or more of the x coordinates of the rectangle. For example, as illustrated in FIGS. 1e1, if the x coordinate of the start selection point (e.g., start selection point 130b is not at the left edge of the content, the minimum x coordinate can be modified so that the content selected extends to the left edge of the content. Similarly, if the x coordinate of the ending release point (e.g., ending release point 134b, is not at the right edge of the content, the maximum x coordinate can be modified so that the content selected extends to the right edge of the content to form rectangle 131b. FIG. 1e1 illustrates a selection object movement that is roughly linear, arrow 132b. Similar logic can be applied when a freeform trajectory is detected, as illustrated in FIGS. 1e2, trajectory 132e. The content in the selection area may be highlighted or distinguished visually in some way from unselected content in display area 1 122a. Selection module 1 106 can select the content in the selection area calculated by the calculation module 108. The logic that is used to calculate the selection area can be provided as heuristics including but not limited to rules such as a rule to determine the number of lines to select given a single touch point (e.g., a starting point or ending point of a finger trajectory). Rules can be customized for the particular user. For example, for a user having a larger finger three lines of text may be included while two lines of text may be included for the same movement made by a user having an average finger. When a smaller font is used, the number of lines included may increase so that the selection made can be customized to the display size, screen resolution, font size, zoom setting and so on. Other rules can specify automatically extending to the end of a word, paragraph, subsection of a page, page, chapter, section, etc.

The computation can determine two or more of the y coordinates of the rectangle. For example, as illustrated in FIG. 1c3, the movement of the selection object across the display surface is illustrated by trajectory 132d, in which the freeform movement of the selection object across the computing device extends above the start selection point 130d and below the ending release point 134d.

As illustrated in FIG. 1c3, a rectangle 131d can be created in which the start selection point and the ending release point are not used to create a diagonal line from which the four vertices are calculated. In accordance with some aspects of the subject matter described herein, a rectangle that includes at least the start selection point and the ending release point and all the points on the trajectory can be created. It will be appreciated that in FIG. 1c2, none of the y-coordinates of the points on the trajectory 132c are greater than the maximum y-coordinate of start selection point 130c. None of the y-coordinates of the points on the trajectory 132c are less than the minimum y-coordinate of ending release point 134c. Hence rectangle 131c is identical to rectangle 131a, formed by the diagonal line 135a between start selection point 130a and ending release point 134a (FIG. 1c1). In FIG. 1c3, however, both the minimum y-coordinate and the maximum y-coordinate occur on the trajectory 132d. The maximum y-coordinate occurs on trajectory 132d at point 136d and the minimum y-coordinate occurs on trajectory 132d at point 137d, forming rectangle 131d.

It will be appreciated that both minimum and maximum y-coordinates need not fall on the trajectory. For example, FIG. 1c4 illustrates an example in which the maximum y-coordinate falls on trajectory 132d1 at point 136d1 but the minimum y-coordinate is the ending release point 134d, creating rectangle 131d1. Similarly, the reverse is possible, in which the minimum y-coordinate falls on the trajectory but the maximum y-coordinate is the start selection point, (not shown). In accordance with other aspects of the subject matter described herein, as illustrated in FIG. 1e5, the y-coordinate of the start selection point can be used for the maximum y-coordinates of the rectangle 131d2 and the y-coordinate of the ending release point can be used for the minimum y-coordinates of the rectangle 131d2 even though the trajectory 132d2 extends above and below the y-coordinates of the start selection point 130d and ending release point 134d.

The computation can determine two or more of the x coordinates of the rectangle and can determine two or more of the y coordinates of the rectangle. For example, as illustrated in FIGS. 1e2 and 1e3, if the x coordinate of the start selection point (e.g., start selection point start selection point 130e and start selection point 130f) is not at the left edge of the content, the minimum x coordinates of the rectangles 131e and 131f can be modified so that the content selected extends to the left edge of the content. Similarly, if the x coordinate of the ending release point (e.g., ending release point 134e and ending release point 134f) is not at the right edge of the content, the maximum x coordinate of the rectangles 131e and 131f can be modified so that the content selected extends to the right edge of the content to form rectangle 131e in FIG. 1e2 and rectangle 131f in FIG. 1ef.

Similar logic can be used to compute the y coordinates, as illustrated in FIG. 1e3. In FIG. 1e3, the trajectory 132f extends above the start selection point 130f. In response, the maximum y coordinate point 136f of the rectangle 131f can be set to the y-coordinate of point 136f of the trajectory 132f. Similarly, if the trajectory 132f extends below the ending release point, the minimum y coordinate of the rectangle can be set to the minimum y-coordinate of the trajectory (not shown). Thus, in accordance with aspects of the subject matter described herein, the minimum y-coordinate of the trajectory can be used for the minimum y-coordinate of the rectangle and the maximum y-coordinate of the trajectory can be used for the maximum y-coordinate of the rectangle, creating a rectangle that includes all the points on the trajectory can be created and used to determine the selection area. In accordance with other aspects of the subject matter described herein, as illustrated in FIG. 1e4, the y-coordinate of the start selection point 130f can be used for the maximum y-coordinates of the rectangle 131g and the y-coordinate of the ending release point 134g can be used for the minimum y-coordinates of the rectangle 131g even though the trajectory 132g extends above the y-coordinates of the start selection point 130f and/or below the ending release point 134f. The content in the selection area may be highlighted or distinguished visually in some way from unselected content in display area 1 122a. Selection module 1 106 can select the content in the selection area calculated by the calculation module.

Content to be selected by selection module 1 106 can be indicated by multiple selection objects. A selection object can be any input device including but not limited to a stylus or other suitable object. A selection object can be a body part such as a finger or other body part. Content to be selected can be indicated by, for example, using two or more fingers on a touch screen. Selection module 1 106 may detect a selection operation by detecting multiple selection objects in contact with a touch-perceiving surface of the computing device. Selection module 1 106 may detect a selection operation by detecting proximity of multiple selection objects to a surface of the computing device. Selection module 1 106 may detect a selection operation by detecting beams of light hitting a surface of a computing device. Selection module 1 106 can determine coordinates of multiple start selection points and multiple ending release points as illustrated in FIG. 1c6 in which a first start selection point 130e1 and first ending release point 134e1 and a second start selection point 130e2 and a second ending release point 134e2 have been detected. The content selected by selection module 1 106 in response to the detected selection information can be determined by calculation module 108.

The computation can determine the y coordinates of the rectangle by detecting the movement of multiple selection objects. For example, as illustrated in FIG. 1c6, the movement of two selection objects across the display surface has been detected. A first start selection point 130e1 and first ending release point 134e1 have been detected and a second start selection point 130e2 and a second ending release point 134e2 have been detected. It will be appreciated that designation of a “first” and/or “second” start selection point is arbitrary and not intended to be limiting. The maximum y-coordinates can be determined by the first start selection point 130e1 and the minimum y-coordinates can be determined by the second start selection point 130e2 to create rectangle 131e1 (or vice versa). If one or more of the start selection points do not fall at the edges of the content, the computation can determine two or more of the x coordinates of the rectangle. For example, as illustrated in FIGS. 1e5, if the x coordinate of the start selection point (e.g., start selection point 130e3 and/or start selection point 130e4) is not at the left or right edge of the content, the minimum x coordinate of rectangle 131e2 can be modified so that the content selected extends to the left edge of the content and/or the maximum x coordinate can be modified so that the content selected extends to the right edge of the content (or vice versa). Similarly, if the y coordinate of the start selection point (e.g., start selection point 130e3 and/or start selection point 130e4) is not at the top or bottom edge of the content, the maximum y coordinate of rectangle 131e2 can be modified so that the content selected extends to the top edge of the content and/or the minimum y coordinate can be modified so that the content selected extends to the bottom edge of the content (or vice versa). The content in the selection area may be highlighted or distinguished visually in some way from unselected content in display area 1 122a. Selection module 1 106 can select the content in the selection area calculated by the calculation module.

Copy module 110 can make a copy of the content selected by selection module 1 106 (i.e., initial content). Copying may be triggered by the breaking of contact or loss of detection of proximity between the selection object and the computing device. Targeting module 112 can receive a target 128 (e.g., a file, etc.) into which content selected by selection module 2 116 (i.e., final content) can be pasted, or edited and pasted. Targeting module 112 can instantiate an instance of an associated application such as application 129, if appropriate. Targeting module 112 can direct display module 114 to load the target 128 into display area 1 122a. For example, suppose the source 126 and the target 128 are word processing documents. Targeting module 112 may instantiate a new instance of MICROSOFT'S WORD®, and direct display module 114 to display target 128 in display area 1 122a, as illustrated in FIG. 1f, in which display area 1 122a displays content of target 128. An indication of where the content to be pasted into target 128 can be received. This is illustrated in FIG. 1f by paste location 138.

Display module 114 can display in a second display area, display area 2 122b, the content copied by the copy module 110, selected content 124, as illustrated in FIG. 1g. Display module 114 can display the second display area, display area 2 122b overlaying display area 1 122a. The content copied by the copy module can be enlarged in the second display area. Selection module 2 116 can receive selection input that identifies the subset of the content to select by receiving a second start selection point and a second end selection point. Alternatively, the coordinates of a start selection point and an ending release point as described above with respect to selection module 1 106 can be used to calculate a selection area. FIG. 1h illustrates receiving selection input that identifies a start selection, start selection point 139a. If all of the selected content is not displayed in display area 2 122b, a scrolling operation can be initiated, illustrated in FIG. 1i. In response to receiving a second end selection point (e.g. end selection point 139b) the indicated content can be pasted into the target 128 at the specified location (e.g., paste location 138, as illustrated in FIG. 1f). Results of the paste operation are displayed in FIG. 1j in which “her time answering the door. This just made the young lady even more impatient.” 134c has been pasted into the target 128.

Optionally the content selected by the second step of the content selection operation can be edited before being pasted into the target, as shown in FIG. 1k. In FIG. 1k, selected content 124 “her time answering the door. This just made the young lady even more impatient.” illustrated in FIG. 1i, has been edited to read “Gremila was slow answering the door. This just made the young lady even more impatient.” edited content 124a. An appropriate content editor can be called to perform the editing process. Results of edit and paste operations are displayed in FIG. 1l.

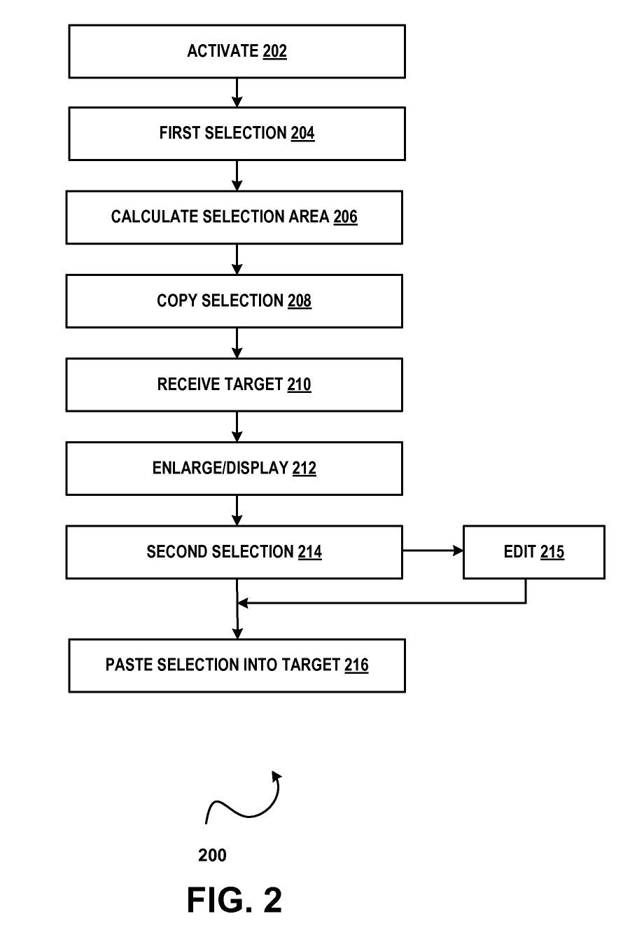

FIG. 2 illustrates an example of a method 200 that enables two step content selection in accordance with aspects of the subject matter described herein. The method described in FIG. 2 can be practiced by a system such as but not limited to the one described with respect to FIG. 1a. While method 200 describes a series of operations that are performed in a sequence, it is to be understood that method 200 is not limited by the order of the sequence depicted. For instance, some operations may occur in a different order than that described. In addition, one operation may occur concurrently with another operation. In some instances, not all operations described are performed.

At operation 202, a first step of a content selection and/or copying operation can be activated on a computing device in some way. Non-limiting examples of activation of such a selection and/or copying operation can include: using a physical movement, using a voice command or in any other suitable way activating a selection and/or copying operation. Physical movements include but are not limited to one or more actions including pressing, pressing and holding, pressing and holding for a particular time period, etc. one or more portions of the computing device. The portion or portions of the computing device that receives the action may be a screen or display portion, keys on a keyboard, a panel, one or more buttons on the computing device, etc.

At operation 204, content to be selected can be indicated in a first step of a content selection operation. Content to be selected can be indicated by, for example, using a stylus, mouse or other input device to select content. Content to be selected can be indicated by, for example, using a finger on a touch screen to select initial content, as described more fully above. Content to be selected can be indicated by one or more selection objects.

At operation 206, a selection area, the area from which content is selected can be calculated. In accordance with some aspects of the subject matter described herein, the content area to be selected is calculated based on the movement of one or more input devices on a portion of a computing device (e.g., movement of two fingers in a grabbing motion on a touch screen). The content area can be calculated using the four vertices of a rectangle derived from the coordinates of the start selection point and the ending release point. Suppose for example, a user selects content by placing an input device (e.g., a finger) on a display device (e.g., a touchscreen) at coordinates (minimum x, maximum y) and without breaking contact between input device and display device, moves the input device across the surface of the display device to a second point at coordinates (maximum x, minimum y), at which contact between the input device and the surface of the display device is broken. The point at which the input device is no longer detected by the selection module is referred to as the ending release point.

A diagonal line from the start selection point to the ending release point can be used to create a rectangle having four vertices calculated from the coordinates of the start selection point and the ending release point. That is, a rectangle can be formed, for example, using the coordinates (minimum x, maximum y), (minimum x, minimum y), (maximum x, maximum y) and (maximum x, minimum y), where (minimum x, maximum y) is the start selection point and (maximum x, minimum y) is the ending release point. The computation can determine two or more x-coordinates for the rectangle. For example, if the x coordinate of the start selection point is not at the left edge of the content, the minimum x coordinate can be modified so that the content selected extends to the left edge of the content. Similarly, if the x coordinate of the ending release point is not at the right edge of the content, the maximum x coordinate can be modified so that the content selected extends to the right edge of the content. The computation can determine two or more y-coordinates for the rectangle. For example, as illustrated in FIG. 1c3, if the trajectory extends above and/or below the start selection point and/or ending release point, the minimum and/or maximum y-coordinates can be modified as described more fully above. Multiple start selection points and multiple ending release points can be used to modify x and/or y-coordinates as described more fully above. The selected content may be highlighted or distinguished visually in some way from unselected content.

At operation 208 content within the selection area can be copied. The copy operation may be triggered by the breaking of contact between the input device and the computing device. At operation 210 a target can be indicated by a user. The target can identify the application that is launched. For example, if a MICROSOFT WORD® document is identified, a WORD editor can be launched. If a MICROSOFT EXCEL® spreadsheet file is identified, EXCEL can be launched and so on. At operation 212 the copied content can be displayed in a second display area associated with the application. Some or all of the copied content can be enlarged. At operation 214 a subset of the initial content comprising final content can be selected in a second step of the content selection operation by indicating a second start selection point and a second end selection point. Content between and including the second start selection point and the second end selection point can be pasted into the target at the paste location at operation 216. Alternatively, content can be edited at operation 215 before pasted into the target at the paste location at operation 216.

### Example of a Suitable Computing Environment

In order to provide context for various aspects of the subject matter disclosed herein, FIG. 3 and the following discussion are intended to provide a brief general description of a suitable computing environment 510 in which various embodiments of the subject matter disclosed herein may be implemented. While the subject matter disclosed herein is described in the general context of computer-executable instructions, such as program modules, executed by one or more computers or other computing devices, those skilled in the art will recognize that portions of the subject matter disclosed herein can also be implemented in combination with other program modules and/or a combination of hardware and software. Generally, program modules include routines, programs, objects, physical artifacts, data structures, etc. that perform particular tasks or implement particular data types. Typically, the functionality of the program modules may be combined or distributed as desired in various embodiments. The computing environment 510 is only one example of a suitable operating environment and is not intended to limit the scope of use or functionality of the subject matter disclosed herein.

With reference to FIG. 3, a computing device in the form of a computer 512 is described. Computer 512 may include at least one processing unit 514, a system memory 516, and a system bus 518. The at least one processing unit 514 can execute instructions that are stored in a memory such as but not limited to system memory 516. The processing unit 514 can be any of various available processors. For example, the processing unit 514 can be a graphics processing unit (GPU). The instructions can be instructions for implementing functionality carried out by one or more components or modules discussed above or instructions for implementing one or more of the methods described above. Dual microprocessors and other multiprocessor architectures also can be employed as the processing unit 514. The computer 512 may be used in a system that supports rendering graphics on a display screen. In another example, at least a portion of the computing device can be used in a system that comprises a graphical processing unit. The system memory 516 may include volatile memory 520 and nonvolatile memory 522. Nonvolatile memory 522 can include read only memory (ROM), programmable ROM (PROM), electrically programmable ROM (EPROM) or flash memory. Volatile memory 520 may include random access memory (RAM) which may act as external cache memory. The system bus 518 couples system physical artifacts including the system memory 516 to the processing unit 514. The system bus 518 can be any of several types including a memory bus, memory controller, peripheral bus, external bus, or local bus and may use any variety of available bus architectures. Computer 512 may include a data store accessible by the processing unit 514 by way of the system bus 518. The data store may include executable instructions, 3D models, materials, textures and so on for graphics rendering.

Computer 512 typically includes a variety of computer readable media such as volatile and nonvolatile media, removable and non-removable media. Computer readable media may be implemented in any method or technology for storage of information such as computer readable instructions, data structures, program modules or other data. Computer readable media include computer-readable storage media (also referred to as computer storage media) and communications media. Computer storage media includes physical (tangible) media, such as but not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices that can store the desired data and which can be accessed by computer 512. Communications media include media such as, but not limited to, communications signals, modulated carrier waves or any other intangible media which can be used to communicate the desired information and which can be accessed by computer 512.

It will be appreciated that FIG. 3 describes software that can act as an intermediary between users and computer resources. This software may include an operating system 528 which can be stored on disk storage 524, and which can allocate resources of the computer 512. Disk storage 524 may be a hard disk drive connected to the system bus 518 through a non-removable memory interface such as interface 526. System applications 530 take advantage of the management of resources by operating system 528 through program modules 532 and program data 534 stored either in system memory 516 or on disk storage 524. It will be appreciated that computers can be implemented with various operating systems or combinations of operating systems.

A user can enter commands or information into the computer 512 through an input device(s) 536. Input devices 536 include but are not limited to a pointing device such as a mouse, trackball, stylus, touch pad, keyboard, microphone, voice recognition and gesture recognition systems and the like. These and other input devices connect to the processing unit 514 through the system bus 518 via interface port(s) 538. An interface port(s) 538 may represent a serial port, parallel port, universal serial bus (USB) and the like. Output devices(s) 540 may use the same type of ports as do the input devices. Output adapter 542 is provided to illustrate that there are some output devices 540 like monitors, speakers and printers that require particular adapters. Output adapters 542 include but are not limited to video and sound cards that provide a connection between the output device 540 and the system bus 518. Other devices and/or systems or devices such as remote computer(s) 544 may provide both input and output capabilities.

Computer 512 can operate in a networked environment using logical connections to one or more remote computers, such as a remote computer(s) 544. The remote computer 544 can be a personal computer, a server, a router, a network PC, a peer device or other common network node, and typically includes many or all of the elements described above relative to the computer 512, although only a memory storage device 546 has been illustrated in FIG. 3. Remote computer(s) 544 can be logically connected via communication connection(s) 550. Network interface 548 encompasses communication networks such as local area networks (LANs) and wide area networks (WANs) but may also include other networks. Communication connection(s) 550 refers to the hardware/software employed to connect the network interface 548 to the bus 518. Communication connection(s) 550 may be internal to or external to computer 512 and include internal and external technologies such as modems (telephone, cable, DSL and wireless) and ISDN adapters, Ethernet cards and so on.

It will be appreciated that the network connections shown are examples only and other means of establishing a communications link between the computers may be used. One of ordinary skill in the art can appreciate that a computer 512 or other client device can be deployed as part of a computer network. In this regard, the subject matter disclosed herein may pertain to any computer system having any number of memory or storage units, and any number of applications and processes occurring across any number of storage units or volumes. Aspects of the subject matter disclosed herein may apply to an environment with server computers and client computers deployed in a network environment, having remote or local storage. Aspects of the subject matter disclosed herein may also apply to a standalone computing device, having programming language functionality, interpretation and execution capabilities.

The various techniques described herein may be implemented in connection with hardware or software or, where appropriate, with a combination of both. Thus, the methods and apparatus described herein, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing aspects of the subject matter disclosed herein. As used herein, the term “machine-readable storage medium” shall be taken to exclude any mechanism that provides (i.e., stores and/or transmits) any form of propagated signals. In the case of program code execution on programmable computers, the computing device will generally include a processor, a storage medium readable by the processor (including volatile and non-volatile memory and/or storage elements), at least one input device, and at least one output device. One or more programs that may utilize the creation and/or implementation of domain-specific programming models aspects, e.g., through the use of a data processing API or the like, may be implemented in a high level procedural or object oriented programming language to communicate with a computer system. However, the program(s) can be implemented in assembly or machine language, if desired. In any case, the language may be a compiled or interpreted language, and combined with hardware implementations.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A system comprising:
at least one processor:
a memory connected to the at least one processor; and
a module that when loaded into the at least one processor causes the at least one processor to:
select content in a first step of a two step content selection operation based on movement of at least two content selection objects comprising a first content selection object and a second content selection object; and
in a second step of the content selection operation, select a subset of the content selected in the first selection operation.

2. The system of claim 1, further comprising:
a module that when loaded into the at least one processor causes the at least one processor to:
determine the content to be selected in the first step of the two step content selection operation by detecting a first start selection point associated with the first content selection object and a second start selection point associated with the second content selection object.

3. The system of claim 1, further comprising:
a module that when loaded into the at least one processor causes the at least one processor to:
select the content in the first step of the content selection operation based on movement of the at least two content selection objects on a touch-perceiving surface of a computing device.

4. The system of claim 2, further comprising:
a module that when loaded into the at least one processor causes the at least one processor to:
calculate a selection area by:
determining an x coordinate of the first start selection point;
determining an x coordinate of the second start selection point;
extending a minimum x coordinate of the selection area to a left edge of the content based on the first start selection point;
extending a maximum x coordinate of the selection area to a right edge of the content based on the second start selection point.

5. The system of claim 2, further comprising:
a module that when loaded into the at least one processor causes the at least one processor to:
calculate a selection area by:
determining a y coordinate of the first start selection point;
determining a y coordinate of the second start selection point;
extending a minimum y coordinate of the selection area to a bottom edge of the content based on the first start selection point; and
extending a maximum y coordinate of the selection area to a top edge of the content based on the second start selection point.

6. The system of claim 1, further comprising:
a module that when loaded into the at least one processor causes the at least one processor to:
enlarge the content selected in the first step of the content selection operation; and
in the second step of the content selection operation determine the subset of the content to select by receiving a start selection point and an end selection point; and
select the determined content.

7. The system of claim 1, further comprising:
a module that when loaded into the at least one processor causes the at least one processor to:
paste the content selected in the second step of the content selection operation into a specified target at a specified paste location.

8. A method comprising:
receiving by a processor of a computing device an indication of content to be selected in a first step of a two step content selection operation, the content to be selected comprising an initial content, the initial content indicated by movement of at least one selection object, the movement indicating a start selection point, and a freeform trajectory extending between the start selection point and an ending release point;
calculating a selection area comprising an area covered by a trajectory of the at least one selection object;
selecting the content within the selection area;
enlarging the first selection in a second display overlaying a first display displaying a target; and
receiving an indication of a subset of the initial content comprising a final content to be selected.

9. The method of claim 8, further comprising:
selecting the content within the selection area, the content within the selection area comprising one of text data, image data, spreadsheet data or calendar data.

10. The method of claim 8, wherein the selection object is a stylus or a finger and the movement comprises moving the selection object over a surface of the computing device.

11. The method of claim 8, wherein the selection are comprises a maximum area covered by the trajectory of the at least one selection object.

12. The method of claim 8, wherein the subset of the first selection is selected by specifying a start selection point and an end selection point.

13. The method of claim 8, further comprising:
limiting the selection area to an area bounded by the start selection point and the ending release point.

14. A computer-readable storage medium comprising computer-readable instructions which when executed cause at least one processor of a computing device to:
perform a first step of a two step content selection operation, the first step selecting initial content based on detecting contact of a content selection object with a surface of a touchscreen of a computing device at a start selection point and detecting maintained contact creating a trajectory to an ending release point;
receive a target;
enlarge the initial content and display the enlarged content;
perform a second step of the two step content selection operation comprising selecting a subset of the initial content, the subset of the initial content comprising a final content.

15. The computer-readable storage medium of claim 14, comprising further computer-readable instructions which when executed cause the at least one processor to:
paste the final content into the target at a specified point in the target.

16. The computer-readable storage medium of claim 14, comprising further computer-readable instructions which when executed cause the at least one processor to:
edit the final content; and
paste the edited final content into the target at a specified point in the target.

17. The computer-readable storage medium of claim 14, comprising further computer-readable instructions which when executed cause the at least one processor to:
receive content comprising text data, image data, spreadsheet data or calendar data.

18. The computer-readable storage medium of claim 14, comprising further computer-readable instructions which when executed cause the at least one processor to:
execute on a computing device comprising a touch screen.

19. The computer-readable storage medium of claim 14, comprising further computer-readable instructions which when executed cause the at least one processor to:
limit the selection area to an area bounded by the start selection point and the ending release point.

20. The computer-readable storage medium of claim 19, comprising further computer-readable instructions which when executed cause the at least one processor to:
expand the selection area to a maximum area covered by the trajectory of the selection object.
